(19) United States
(12) Patent Application Publication
(10) Pub. No.: US 2008/0080734 A1
(43) Pub. Date: Apr. 3, 2008

(54) Sports audio player and two-way voice/data communication device

(76) Inventors: Robert A. Forth, Glendora, CA (US); David K. Boyle, Monrovia, CA (US)

Correspondence Address: KHORSANDI PATENT LAW GROUP, A.L.C., Suite 312, 140 South Lake Avenue, Pasadena, CA, 91101-4710, US

(21) Appl. No.: 11/906,662

(22) Filed: Oct. 3, 2007

Related U.S. Application Data
(60) Provisional application No. 60/848,877, filed on Oct. 3, 2006.

(51) Int. Cl. H04R 1/02

(52) U.S. Cl. 381/386

(57) ABSTRACT

An exemplary embodiment of the present invention docks a waterproof audio device into a recess in a top surface of a bodyboard (or other craft used in aquatic sports or related activities). Docking the device into the body of the craft serves to protect the device from impacts and mechanical stresses. The exemplary device comprises flat panel audio transducers, for example distributed mode loudspeakers and/or piezo transducers, or other flat panel audio transducer technologies, whether now known or in the future developed. The exemplary device is adapted for generating audio frequencies to produce high fidelity audio at sound pressure levels sufficient for the high noise environment that exists in aquatic sports. In the exemplary embodiment, the audio transducer(s) are acoustically coupled into the surface of the participant's aquatic sport craft and into the body of the craft. As a result of the acoustical coupling, the surface of the board, and the body of the board, act a distributed mode loudspeaker. In the exemplary embodiment, music playback is temporarily “paused” by two-way radio voice/data communication or by submersion of the device as detected by a submersion sensor. When incoming communication stops, or the device is no longer submerged, the music continues from the point it left off. This allows the participant to hear priority messages over the music program. It also allows the participant to resume music playback after surfacing. Further, the participant's ears are not obstructed so that verbal two-way voice/data communication with other participants nearby is no longer inhibited. The exemplary device has no visual display. Rather, the user interface is simplified, announcing verbal cues when switches are depressed. For example, when the participant depresses a volume key, the exemplary device announces “Volume Up.”

### CROSS REFERENCE TO RELATED APPLICATIONS

This application claims priority to U.S. Provisional Patent Application Ser. No. 60/848,877 titled “Waterproof Audio Player & 2-Way Voice/Data Communication Device”, filed on Oct. 3, 2006, the entire contents and disclosure of which is incorporated herein in full by reference as if stated in full herein.

### FIELD OF THE INVENTION

The field of the present invention is audio players and communication devices, in particular, audio players and communication devices used in sports, such as, for example, aquatic sports, and related activities.

### BACKGROUND OF THE INVENTION

Participants in sports are limited, or in some cases, may be unable, to listen to music and/or communicate as they participate in their sport. Aquatic sports present various examples. For example, bodyboarders may want to listen to music while on the ocean between wave sets. If the music device is submerged, if the music continues to play, the bodyboarder or other aquatic sports participant misses the portion of the music that is played while the device is submerged. As another example, people exercising with a paddleboard may want to listen to books-on-tape while exercising. As yet another example, people on the beach may want to use a device to listen to music and or communicate with friends who are, for example, surfing or bodyboarding.

In aquatic sports, music being played by conventional devices, such as, for example, a radio, or an MP3 player, continues to play even if the user is unable to hear the music due to extreme ambient levels (for example, an ocean wave collapses), competing audio sources, or submersion.

Some music devices have been made waterproof and are made to be worn by the user. Some such waterproof music devices employ ear mounted speakers fitted with water barriers. However, extreme hydrodynamic forces encountered by aquatic sport participants such as bodyboarders, surfers, kayakers, wakeboards, etc. aggressively dislodge ear mounted speakers. Once dislodged these music players suffer degraded fidelity due to either partial or total interruption of the water barrier. Ear-mounted speakers obscure the wearer's ability to hear external sound and environmental cues such as waves, nearby surfers, and directions from a lifeguard and may prevent and/or interfere with normal conversation between participants and others nearby, for example other bodyboarders, kayaks, and surfers.

Loud speakers of standard design work poorly in aquatic environments. Their concave shape easily fills with water and stop functioning when covered with water.

Some waterproof music devices have been made to be secured to the surface of an aquatic sports device. Such devices create a high profile with respect to the surface of the aquatic sports device that tends to interfere with comfort and/or movement by the aquatic sports participant.

Aquatic sport participants often need a high degree of mobility. A device that uses cords, wires, straps, harnesses etc. to transmit sounds to the user, and/or to secure the device to the user and/or to the aquatic sports device may limit and/or interfere with the participant's mobility.

Further, aquatic sports participants may want to share music programs in real time or engage in two-way voice/data communication with others remotely located. For example, a person on the beach may want to communicate with a bodyboarder in the water. Or a bodyboard instructor, (on his bodyboard), may want to communicate with a student on a separate bodyboard.

Merely placing a two-way radio or digital music player into a waterproof bag or container would not provide sufficient audio levels under some circumstances. For example, audio levels traveling through the waterproof bag or container are attenuated, making it difficult to hear the audio in high ambient noise situations.

Further, merely placing a two-way radio or digital music player into a waterproof bag or container requires the aquatic sports participant to manipulate whatever standard controls and/or view displays while the device is in the waterproof bag or container. Trying to manipulate complex controls and view displays on devices that are contained in a bag may be difficult, especially if the aquatic sports participant's attention is focused on engaging in the relevant sport. Further, when a waterproof bag or container contacts cold water, internal humidity may condensate on the device which can damage sensitive electronic devices and/or may compound the difficulty of manipulating complex controls and/or viewing displays on devices enclosed in such a waterproof bag or container. Further, the aquatic sports participant may be distracted by manipulating controls and/or viewing displays, and may fail to recognize a possible dangerous situation such as an approaching surfer.

Further, terrestrial-based digital music players and two-way radios may be damaged by extremes of shock, vibration, and foreign matter ingression prevalent in aquatic sports.

Accordingly, an aquatic sports participant needs a unique music and two-way communication device that is capable of operating in such challenging environments without interfering with the aquatic sports participants' mobility and concentration.

### SUMMARY OF THE INVENTION

An exemplary embodiment of the present invention docks a waterproof audio device into a recess in a top surface of a bodyboard (or other craft used in aquatic sports or related activities). Docking the device into the body of the craft serves to protect the device from impacts and mechanical stresses.

The exemplary device comprises a flat panel audio transducer acoustically coupled to a flat panel audio interface panel.

The exemplary device comprises flat panel audio transducers, for example distributed mode audio transducers and/or piezo transducers, and/or other flat panel audio transducer technologies, whether now known or in the future developed.

The exemplary device is adapted for generating audio frequencies to produce high fidelity audio at sound pressure levels sufficient for the high noise environment that exists in aquatic sports. In the exemplary embodiment, the audio transducer(s) are acoustically coupled into the surface of the participant's aquatic sport craft and into the body of the craft. As a result of the acoustical coupling, the surface of the board, and the body of the board, act as a distributed mode loudspeaker.

In the exemplary embodiment, music playback is temporarily “paused” by two-way radio voice/data communication or by submersion of the device as detected by a submersion sensor. When incoming communication stops, or the device is no longer submerged, the music continues from the point it left off. This allows the participant to hear priority messages over the music program. It also allows the participant to resume music playback after surfacing. Further, the participant's ears are not obstructed so that verbal two-way voice/data communication with other participants nearby is no longer inhibited. The exemplary device has no visual display. Rather, the user interface is simplified, announcing verbal cues when switches are depressed. For example, when the participant depresses a volume key, the exemplary device announces “Volume Up.”

### BRIEF DESCRIPTION OF THE DRAWINGS

These and other features of the present invention are more fully set forth in the following description of exemplary embodiments of the invention. The description is presented with reference to the accompanying drawings in which:

FIG. 1 depicts a cross-sectional view of an exemplary audio device docked into a cradle that is mounted into a bodyboard in an exemplary embodiment of the present invention;

FIG. 2 depicts a perspective view of a human aquatic sport participant riding on a bodyboard in which the exemplary device of the exemplary embodiment of the present invention is docked;

FIG. 3 depicts a cross-sectional exploded view of the device of the exemplary described embodiment of the present invention adapted for docking into an exemplary cradle in a body of a craft the cradle using an exemplary shaft and an exemplary quarter-turn fastener;

FIG. 4 depicts a perspective view of an exemplary recess in a body of a craft in an exemplary embodiment of the present invention;

FIG. 5 depicts a side plan view of the exemplary device of the exemplary embodiment of the present invention;

FIG. 6 depicts a top plan view of the exemplary device of the exemplary embodiment of the present invention;

FIG. 7 depicts an exploded perspective view of an exemplary user interface panel, an exemplary upper housing component, and an exemplary rubber ring of the exemplary device of the present invention;

FIG. 8 depicts a perspective view of the exemplary device of the present invention being recessed and docked into an exemplary tow raft;

FIG. 9 depicts a perspective view of the exemplary device of the present invention being recessed and docked into an exemplary surfboard;

FIG. 10 depicts a perspective view of the exemplary device of the present invention being recessed and docked into an exemplary paddle board;

FIG. 11 depicts a perspective view of the exemplary device of the present invention being recessed and docked into an exemplary wind surfing board;

FIG. 12 depicts a perspective view of the exemplary device of the present invention being recessed and docked into an exemplary kayak;

FIG. 13 is a high-level block diagram depicting exemplary components of exemplary device 1 in the exemplary embodiment of the present invention;

FIG. 14 is a graph that depicts results of empirical tests regarding audio levels produced by exemplary device of the exemplary embodiment of the present invention;

FIG. 15 depicts a cross-sectional view of a top-mounted device, cradle and form in an alternative embodiment of the present invention;

FIG. 16 depicts an exploded cross-sectional view of a top-mounted device, cradle and form in an alternative embodiment of the present invention;

FIG. 17 depicts a cross-sectional view of a top-mounted device in a further alternative embodiment of the present invention; and

FIG. 18 depicts a perspective view of an alternative embodiment in which a plurality of transducers are imbedded in a bodyboard underneath the top surface of the board.

### DETAILED DESCRIPTION OF THE INVENTION

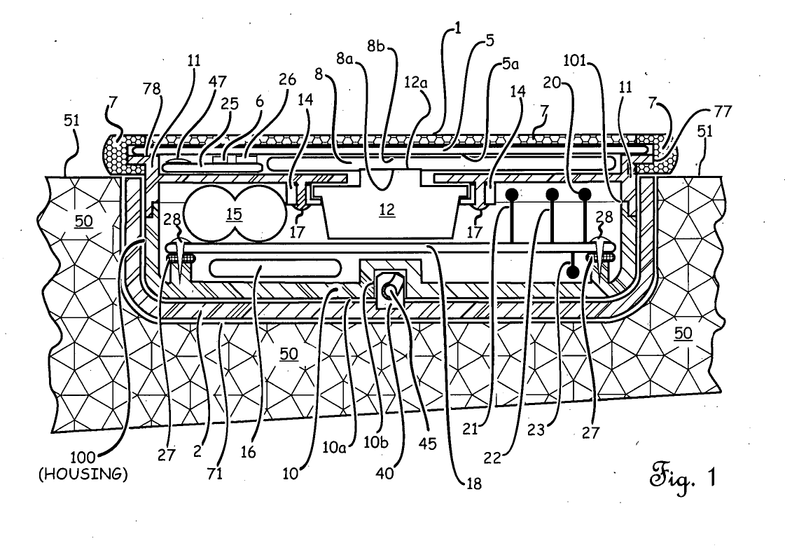

FIG. 1 depicts a cross-sectional view of a portion of an exemplary embodiment of the present invention. As depicted in FIG. 1, the exemplary embodiment of the present invention comprises an exemplary waterproof audio device 1 that comprises an exemplary waterproof, watertight, housing 100.

The exemplary waterproof housing 100 of the exemplary embodiment comprises an exemplary lower housing component 10 and an exemplary upper housing component 11. In the exemplary embodiment, the exemplary lower housing component 10 and the exemplary upper housing component 11 are joined together and sealed through ultrasonic bonding at a sealed joint 101. It will be understood by someone with ordinary skill in the art that the description herein of ultrasonic bonding of the exemplary lower housing component 10 and the exemplary upper housing component 11 is exemplary and non-limiting.

It will be understood by someone with ordinary skill in the art that other methods of joining and sealing the upper housing component 11 with the lower housing component 10 could be used without departing from the spirit of the present invention. For example, the exemplary lower housing component 10 could be joined with and sealed to the exemplary upper housing component 11 using a rubber seal, such as, for example, exemplary rubber ring 7, and/or mechanical fasteners. Other permanent and non-permanent joining and sealing methods are possible, whether now known or in the future discovered.

Further, it will be understood by someone with ordinary skill in the art that the description of two housing components 10 and 11 is illustrative and non-limiting. Rather, in alternative embodiments, it would be possible to provide a single-component housing.

The exemplary device 1 is hardened against extremes in water pressure, temperature, shock, vibration, and foreign matter intrusion that are typical found in aquatic sport environments. The exemplary device 1 meets environmental specifications of at least International Standard CEI/IEC 529: 1989:IPX7.

It will be understood by someone with ordinary skill in the art that the description herein of the exemplary device 1 as meeting the specific environmental specifications of International Standard CEI/IEC 529: 1989:IPX7 is exemplary and non-limiting. In alternative embodiments of the present invention, the exemplary device may be housed in a housing that is not waterproof, watertight, submersible or otherwise ruggedized against environmental elements. In some alternative embodiments, the housing may be sealed to resist dust entering the interior of the housing.

Exemplary lower housing component 10 comprises an exemplary cylindrical shaft 45 attached to, and extending from an exemplary docking recess 10b in the bottom surface 10a of exemplary lower housing component 10.

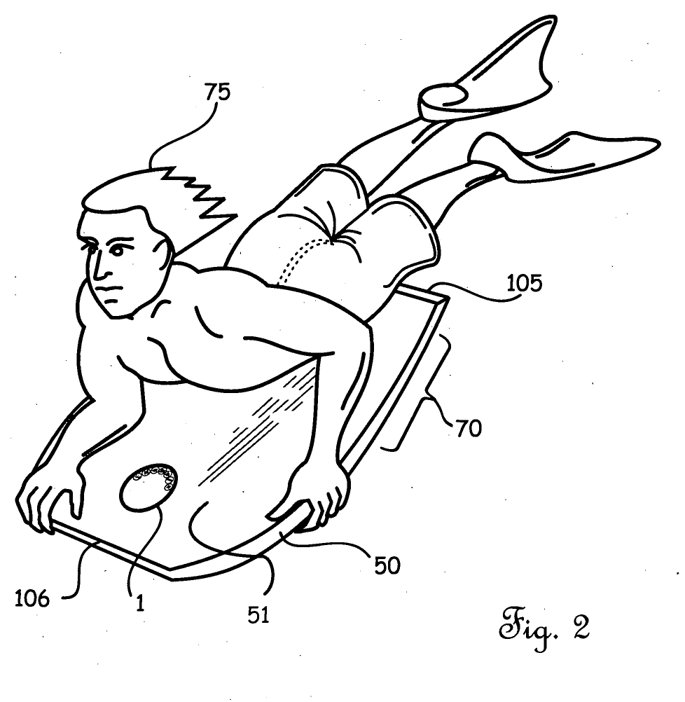

The exemplary embodiment further comprises an exemplary body 50 of material. In the exemplary embodiment, the exemplary body 50 comprises a bodyboard of common design. An exemplary bodyboard 70 of the exemplary embodiment of the present invention is depicted in FIG. 2. It will be understood by someone of ordinary skill in the art that the description herein of the exemplary body 50 comprising an exemplary bodyboard 70 as depicted in FIG. 2 is illustrative and non-limiting.

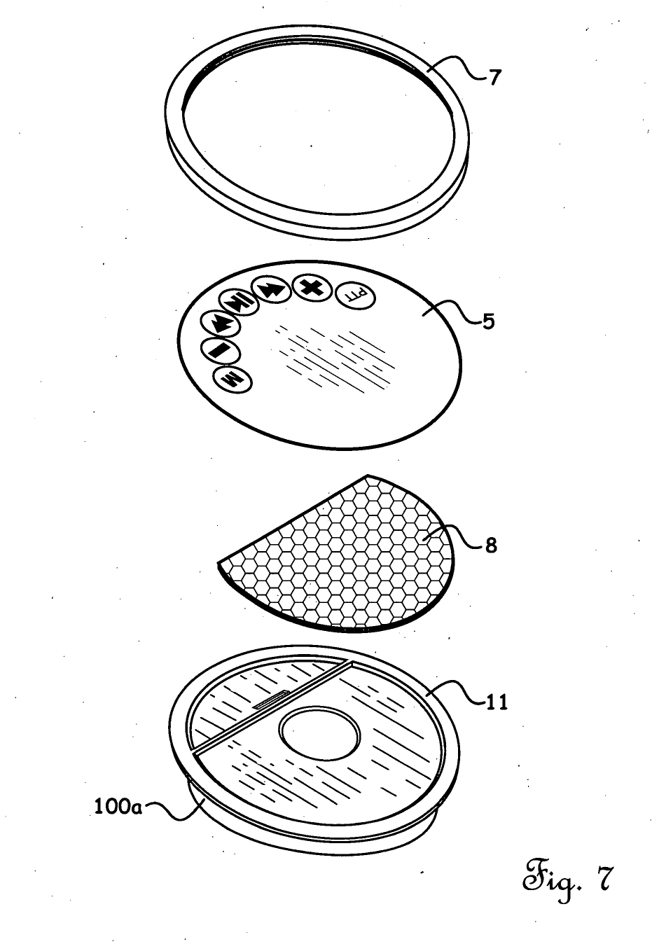

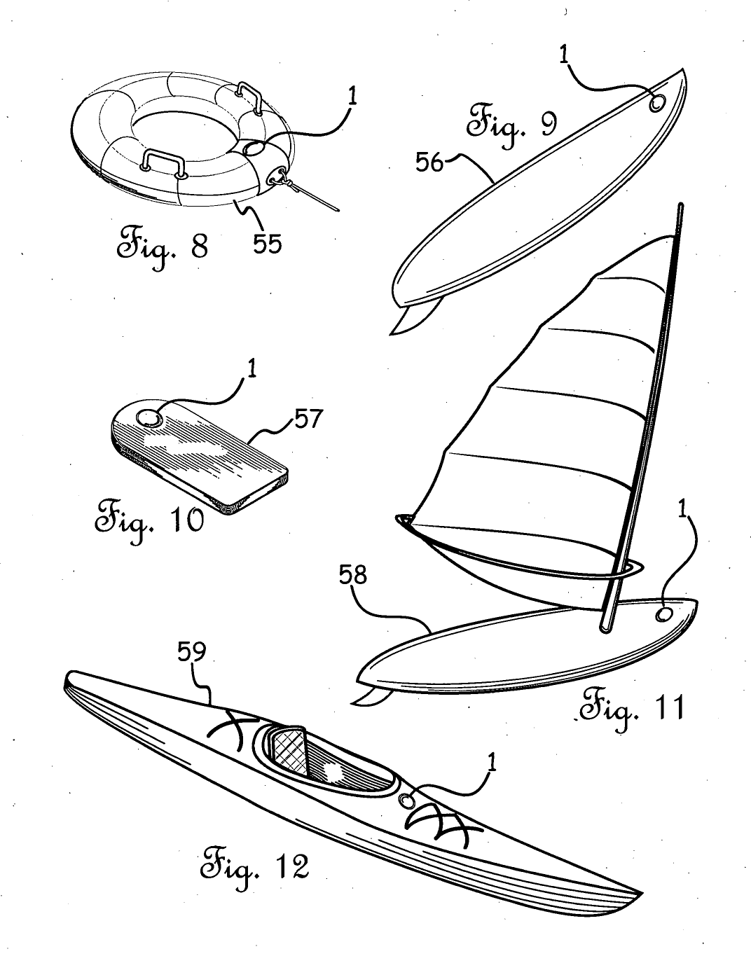

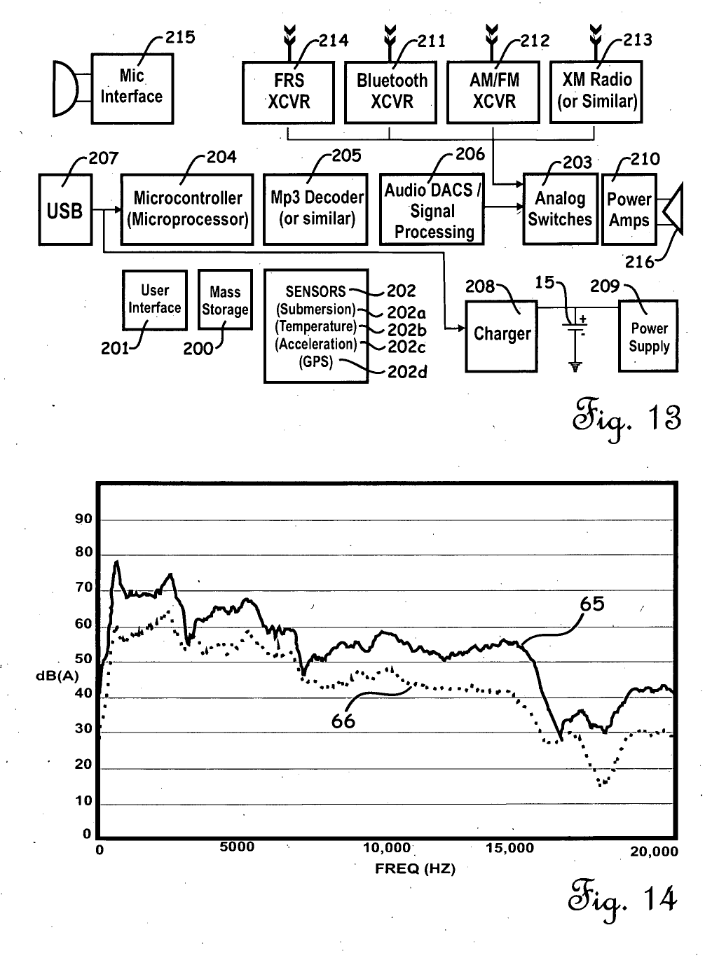

In alternative embodiments, a body 50 may comprise a float tube or tow raft 55 an example of which is depicted in FIG. 8, a surfboard 56 of common design an example of which is depicted in FIG. 9, a paddle board 57 of common design an example of which is depicted in FIG. 10, a windsurfer board 58 of common design an example of which is depicted in FIG. 11, a kayak 59 of common design an example of which is depicted in FIG. 12, or other crafts, apparatus or bodies of material. It will be understood by someone with ordinary skill in the art that the aforementioned integrations of the exemplary device as shown in FIGS. 8, 9, 10, 11, and 12 are illustrative only. Rather, integrations into other platforms, crafts and/or apparatus could be provided without departing from the spirit of the present invention.

FIG. 8 depicts a perspective view of the exemplary device 1 being recessed and docked into an exemplary tow raft 55. The exemplary tow raft 55 depicted in FIG. 8 is illustrative, and one of numerous such designs that can be used to float a person and/or can be towed behind a boat.

FIG. 9 depicts a perspective view of the exemplary device 1 being recessed and docked into an exemplary surfboard 56. The exemplary surfboard 56 depicted in FIG. 9 is illustrative and non-limiting and is not intended to depict a specific type of surfboard. Rather, it will be understood by someone with ordinary skill in the art that there are a multitude of geometries, materials, and optimizations of surfboards. The exemplary device 1 could be recessed and/or docked and/or bonded into or onto any of such surfboard configurations without departing from the spirit of the present invention.

FIG. 10 depicts a perspective view of the exemplary device 1 being recessed and docked into an exemplary paddle board 57. Exemplary paddle board 57 is of the type typically used for swim training and/or pool exercising and its depicting in FIG. 10 is illustrative and non-limiting and is not intended to depict a specific type or configuration of paddle board. Rather, it will be understood by those with ordinary skill in the art that there are a multitude of geometries, materials, and optimizations of paddle boards. The exemplary device 1 could be recessed and/or docked and/or bonded into or onto any of such paddle board configurations without departing from the spirit of the present invention.

FIG. 11 depicts a perspective view of the exemplary device 1 being recessed and docked into an exemplary wind surfing board 58. Depicting exemplary wind surfing board 58 in FIG. 11 is illustrative and non-limiting and is not intended to depict a specific type or configuration of wind surfing board. Rather, it will be understood by those with ordinary skill in the art that there are a multitude of geometries, materials, and optimizations of wind surfing boards. The exemplary device 1 could be recessed and/or docked and/or bonded into or onto any of such wind surfing board configurations without departing from the spirit of the present invention.

FIG. 12 depicts a perspective view of the exemplary device 1 being recessed and docked into an exemplary kayak 59. Depicting exemplary kayak 59 in FIG. 12 is illustrative and non-limiting and is not intended to depict a specific type or configuration of wind surfer. Rather, it will be understood by those with ordinary skill in the art that there are a multitude of geometries, materials, and optimizations of kayaks. The exemplary device 1 could be recessed and/or docked and/or bonded into or onto any of such kayak configurations without departing from the spirit of the present invention.

It will be understood that the above-described examples are illustrative and non-limiting. The exemplary device 1 could be docked in various other crafts, including, by way of non-limiting example, a recess in an arm of a beach chair, cooler or other furniture, in a recess in a dashboard of a boat or car, or in a recess in the surface of a snowboard or wakeboard. The exemplary device 1 could be disengaged from one craft and docked into another craft, or even used independently.

Returning with reference to FIG. 1, the exemplary body 50 of the exemplary embodiment further comprises an exemplary body top surface 51. The exemplary body 50 of the exemplary embodiment further comprises an exemplary recess 71.

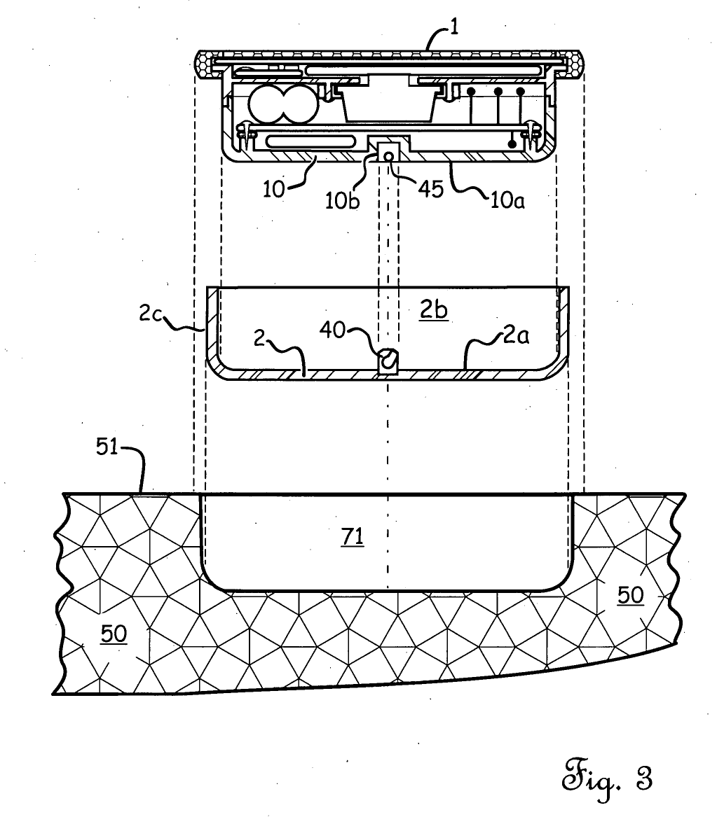

FIG. 4 depicts an exploded perspective view of the exemplary embodiment of the device 1 removed from exemplary cradle 2, which has been removed from exemplary recess 71 in exemplary body top surface 51 of exemplary body 50 of bodyboard 70. In the exemplary embodiment, the exemplary recess 71 in exemplary body 50 is cylindrical in shape. Exemplary recess 71 comprises a floor 71a and an interior wall 71b. However, as will be understood by someone with ordinary skill in the art, the description herein of a cylindrical shape of exemplary recess 71 is illustrative and non-limiting. Rather, other shapes of recess 71 could be used without departing from the spirit of the present invention.

Continuing with reference to FIG. 1, an exemplary cradle 2 is seated within exemplary recess 71. In the exemplary embodiment, an exterior 2c (see element 2c in FIG. 3) of exemplary cradle 2 is bonded into recess 71.

With reference to FIG. 3, in the exemplary embodiment, exemplary cradle 2 comprises an exemplary quarter turn fastener 40 attached to the bottom surface 2a of the well (or cradle recess) 2b of the cradle 2. As will be explained further below, exemplary quarter turn fastener 40 is used to engage exemplary cylindrical shaft 45, which is attached to, and extending from docking recess 10b in the bottom surface 10a of exemplary lower housing component 10 of exemplary housing 100 (see element 100 in FIG. 1).

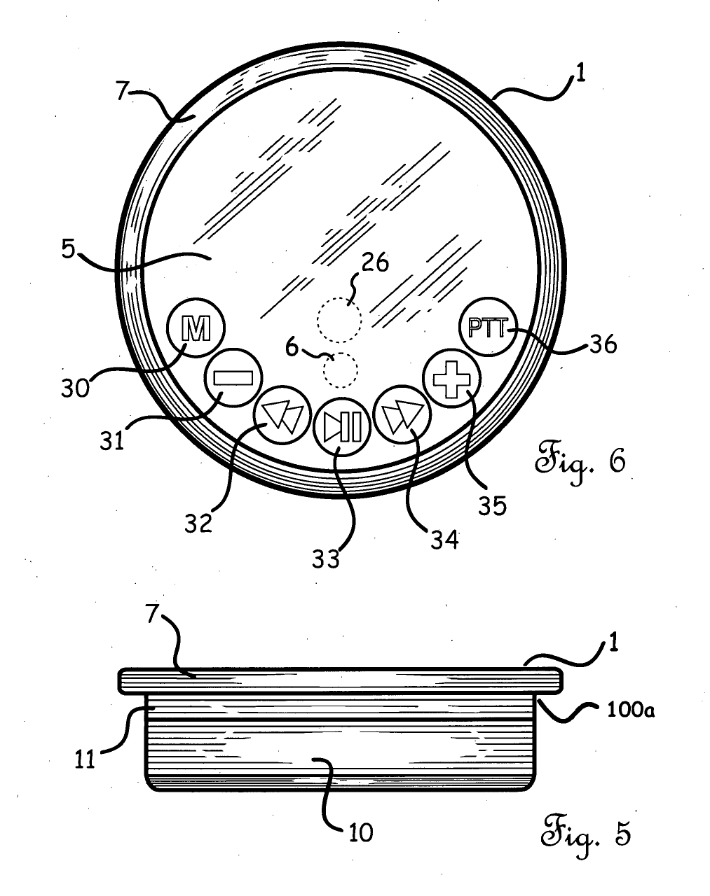

In the exemplary embodiment, exemplary housing 100 depicted in FIG. 1 is cylindrical in shape and comprises a cylindrical shaft 100a as depicted in FIGS. 4 and 7.

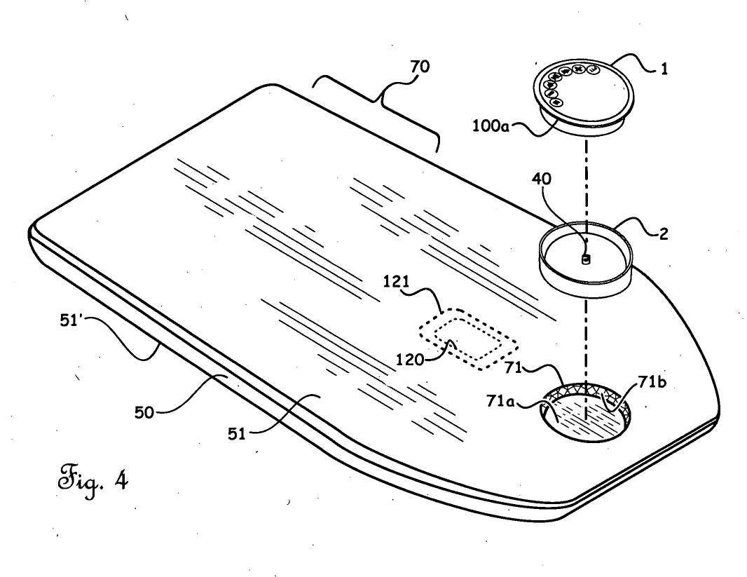

Returning with reference to FIG. 1, in the exemplary embodiment, exemplary housing 100 further comprises an exemplary exterior rim 77 around the upper edge of the circumference (perimeter) of exemplary upper housing component 11. In the exemplary embodiment, exemplary rubber ring 7 surrounds exemplary exterior rim 77 of exemplary upper housing component 11. As depicted in FIG. 5, exemplary rubber ring 7 extends over and encircles a portion of exemplary user interface panel 5, and an upper portion of exemplary upper housing component 11. FIG. 6 depicts a top plan view of exemplary rubber ring 7 encircling the exemplary exterior rim (not visible) of the housing 100 (not visible). In the exemplary embodiment, exemplary rubber ring 7 protects the exemplary waterproof device 1, and also couples acoustic energy from the exemplary device 1 into the exemplary body 50.

Returning with reference to FIG. 1, in the exemplary embodiment, exemplary housing further comprises an exemplary user interface panel 5. In the exemplary embodiment, exemplary user interface panel 5 is bonded by adhesives to an exemplary top surface 78 of exemplary upper housing component 11. FIG. 7 depicts an exploded perspective view of exemplary rubber ring 7, exemplary user interface panel 5, exemplary acoustic interface panel 8, and exemplary upper housing component 11. In the exemplary embodiment, exemplary user interface panel 5 comprises a thin polyester material that acts as a sound board for acoustic energy. It will be understood by someone with ordinary skill in the art that other materials and geometries could be used to form an interface panel that would conduct acoustic energy without departing from the spirit of the present invention. That is, the description of the exemplary embodiment comprising a substantially cylindrical housing is illustrative and non-limiting; other shapes could be used without departing from the spirit of the present invention.

As depicted in FIG. 6, exemplary user interface panel 5 comprises exemplary graphic elements 30, 31, 32, 33, 34, 35, and 36 that define tactile user switch locations. Exemplary user interface panel graphic element 30 comprises a tactile user switch location for activating mobile two-way communication with another device. Exemplary user interface panel graphic element 31 comprises a tactile user switch location for reducing the volume of audio sound. Exemplary user interface panel graphic element 32 comprises a tactile user switch location for navigating to the previous audio selection. Exemplary user interface panel graphic element 33 comprises a tactile user switch location for pausing play of a current audio selection. Exemplary user interface panel graphic element 34 comprises a tactile user switch location for navigating to the next audio selection. Exemplary user interface panel graphic element 35 comprises a tactile user switch location for increasing the volume of audio sound. Exemplary user interface panel graphic element 36 comprises a tactile user switch location for party line communication.

It will be understood by someone with ordinary skill in the art that the description herein of the exemplary graphic elements 30, 31, 32, 33, 34, 35, and 36 is illustrative and non-limiting; other graphic elements, switch configurations, materials, thickness, and geometries of exemplary user interface 5 are possible without departing from the spirit of the present invention.

In the exemplary embodiment, the bonds at the sealed joint 101 between exemplary upper housing component 11 and exemplary lower housing component 10, and between exemplary user interface panel 5 and exemplary inner rim 78 of exemplary upper housing component 11 hermetically seal within the exemplary housing 100, various audio and communications related components described further below.

Returning to FIG. 1, the exemplary waterproof audio device 1 of the exemplary embodiment of the present invention further comprises at least one exemplary distributed mode audio transducer 12 retained within exemplary waterproof housing 100 by retaining bracket 14. In the exemplary embodiment, distributed mode audio transducers such as NXT™ exciters are used. However, it will be understood by someone with ordinary skill in the art that the description of use of NXT™ exciters is illustrative and non-limiting. In alternative embodiments, other types of distributed mode audio transducers could be used without departing from the spirit of the present invention. Further, in other alternative embodiments, pistonic transducers, flat panel piezo transducers, or other audio transducers or systems capable of generating or producing audio frequencies, whether now known or in the future discovered, could be used without departing from the spirit of the present invention.

Continuing with reference to FIG. 1, the exemplary waterproof audio device 1 of the exemplary embodiment of the present invention further comprises an exemplary printed circuit board 18, an exemplary inductive battery charger 16 and exemplary rechargeable batteries 15. In the exemplary embodiment, exemplary inductive battery charger 16 is connected to, and is adapted for charging, exemplary rechargeable batteries 15.

In the exemplary embodiment, exemplary rechargeable batteries 15 provide electrical power to various electrical components described further below. In the exemplary embodiment, rechargeable batteries 15 comprise rechargeable lithium batteries. It will be understood by someone with ordinary skill in the art that the use of rechargeable lithium batteries in the exemplary embodiment is illustrative and non-limiting; other battery technologies and methods of supplying power, whether now known or in the future discovered, could be used without departing from the spirit of the present invention. For example, in alternative embodiments, by way of non-limiting example, nickle-metal-hydride, nickel-cadmium, replaceable alkaline, or photovoltaic (solar), could be used without departing from the spirit of the present invention. In yet another embodiment, a dock (not shown) adapted for accepting the device 1 could be used that would connect the docked device 1 to a personal computer (“PC”) or other device USB port; the USB port would be adapted for downloading music files to the alternative device music file download and battery charging.

In the exemplary embodiment, as depicted in FIG. 1, exemplary inductive battery charger 16 is located in the bottom of the lower housing 10. When exemplary inductive battery charger 16 is positioned in proximity to an appropriate alternating current (“AC”) electrical field, such as a desktop docking bay, a current is induced into exemplary inductive battery charger 16; exemplary inductive battery charger 16 will then charge exemplary rechargeable batteries 15. In the exemplary embodiment, printed circuit board 18 would comprise exemplary battery charging circuitry, exemplary battery power monitoring circuitry, and power conditioning circuitry.

In the exemplary embodiment, exemplary printed circuit board 18 comprises exemplary circuitry to facilitate all functions of exemplary device 1, including, but not limited to, exemplary microprocessor circuitry, exemplary microcontroller circuitry, and exemplary dedicated circuitry for controlling exemplary radio transceivers, exemplary receivers, exemplary decoders, exemplary digital interfaces, and exemplary user interfaces; exemplary printed circuit board 18 comprises exemplary circuitry for facilitating music upload and download, audio playback, signal processing, power control, and manipulation of all audio and data sources. Further, exemplary printed circuit board 18 comprises exemplary memory mass storage devices to facilitate playback of stored digitally encoded music files (e.g., MP3, WMA, etc). It will be understood by someone with ordinary skill in the art that description herein of specific types of digitally encoded music files, such as MP3, WMA, etc., is illustrative and non-limiting; other types of digital encoding, whether now known or in the future discovered, could be used without departing from the spirit of the present invention.

In the exemplary embodiment, exemplary printed circuit board 18 is mounted to exemplary lower housing component 10 using exemplary screws 28 and exemplary elastomeric isolators 27. Exemplary elastomeric isolators 27 protect exemplary printed circuit board 18 from shock, vibration and acoustic energy.

Continuing with reference to FIG. 1, the exemplary waterproof audio device 1 of the exemplary embodiment of the present invention further comprises exemplary data antenna 23. In the exemplary device 1, exemplary data antenna 23 is mounted on exemplary printed circuit board 18. In the exemplary device 1, exemplary data antenna 23 is adapted for transmitting and receiving high speed digital data via an exemplary wireless data link, such as, for example, a BLUETOOTH® wireless data link. In the exemplary embodiment, the exemplary BLUETOOTH® wireless data link comprises an exemplary BLUETOOTH® transceiver imbedded in exemplary printed circuit board 18. In the exemplary embodiment, the exemplary BLUETOOTH® wireless data link facilitates uploading and downloading of music programs by the user, software for operating exemplary device 1, verbal feedback ques, remote control commands, digital audio, and various software algorithms and commands. Additionally, in the exemplary embodiment, the BLUETOOTH® wireless data link can be used to facilitate two-way voice/data communication between exemplary compatible devices, as well as other devices such as cell phones, PDA's (Personal Data Assistant), and wireless hubs.

It will be understood by someone with ordinary skill in the art that use in the exemplary embodiment of BLUETOOTH® wireless technology is illustrative and non-limiting; other wireless protocols whether now known or in the future discovered, such as, for example, 802.11, and other types of devices and messages could be used without departing from the spirit of the present invention. Alternatively, wired methods of data transfer, such as, for example, USB, could also be used without departing from the spirit of the present invention.

Continuing with reference to FIG. 1, the exemplary waterproof audio device 1 of the exemplary embodiment of the present invention further comprises exemplary radio signal antenna 21 is adapted for receiving common AM and FM broadcast radio signals. In the exemplary embodiment, exemplary radio signal antenna 21 is further adapted for transmitting and receiving music program to/from neighboring devices that are similar to exemplary device 1. Accordingly, with a plurality of specimens of exemplary device 1, groups of users can all listen to (share) a single user's music program in real time.

In the exemplary embodiment, exemplary radio signal antenna 21 is further adapted for transmitting and receiving Radio Broadcast Data System (RBDS) signals for configuration, command, and remote control of exemplary device 1. In the exemplary embodiment, an exemplary AM, FM, and RBDS transceiver connected to exemplary radio signal antenna 21 is imbedded in exemplary printed circuit board 18.

Continuing with reference to FIG. 1, the exemplary waterproof audio device 1 of the exemplary embodiment of the present invention further comprises exemplary digital/satellite signal antenna 22. In the exemplary embodiment, exemplary digital/satellite signal antenna 22 is adapted for receiving digital music program from both terrestrial and Earth satellite sources. In the exemplary device 1, XM™ satellite radio would be used. In the exemplary embodiment, an exemplary digital music transceiver corresponding to exemplary digital/satellite signal antenna 22 is imbedded in exemplary printed circuit board 18. It will be understood by someone with ordinary skill in the art that use in the exemplary embodiment of XM™ is illustrative and non-limiting; other wireless protocols, frequencies, modulation techniques and types of messages could be used without departing from the spirit of the present invention.

Continuing with reference to FIG. 1, the exemplary waterproof audio device 1 of the exemplary embodiment of the present invention comprises an exemplary two-way communication antenna 20. In the exemplary embodiment, exemplary two-way communication antenna 20 is adapted for receiving and transmitting two-way voice and communications and data messaging. In the exemplary embodiment, Family Radio Service (FRS) protocol is used for two-way voice and data messaging. In the exemplary embodiment, an exemplary FRS transceiver corresponding to exemplary two-way communication antenna 20, is imbedded in exemplary printed circuit board 18. In the exemplary embodiment, the exemplary FRS transceiver would be operable to communicate using the Family Radio Service (FRS) portion of the radio frequency spectrum. The FRS is defined by the 47 Code of Federal Regulation (CFR), section 95, which is incorporated herein for all purposes by reference. 47 CFR section 95 governs personal telecommunications. The FRS radio spectrum is administered by the Federal Communications Commission (FCC). Frequency of FRS operation is between 462.5625 MHz and 467.7125 MHz. FRS is used primarily for voice communications. However, communication of tones and data is authorized.

In one embodiment, the waterproof device 1 would comprise a two-way FRS radio that would be operated in a “slave mode” to facilitate two-way voice communication while relieving the user of the task channel and privacy code assignments. In such an embodiment, the waterproof device 1 would enter a “slave mode” that would listen for, and that would synchronize to a “master” radio. Subsequently, the waterproof device 1, in “slave mode” would follow the master radio's channel and code commands.

In another embodiment, the waterproof device 1 would comprise a two-way FRS radio operated in a “party line” mode, whereby all local or nearby like devices would be capable of, and adapted for, monitoring and communicating with each other. In such a party line communication embodiment, the waterproof device 1 would enter/exit the “party line” mode with the touch of one button. In such an embodiment, the “party line” channel and code assignment would be fixed and hidden from the user.

It will be understood by someone with ordinary skill in the art that there are advantages to using transceivers operable to communicate within the FRS spectrum for aquatic sports communications. One advantage is that the operable FRS frequency range (between 462.5625 MHz and 467.7125 MHz) facilitates the use of small antenna and other components due to the short wavelength at these frequencies.

Another advantage of using FRS-capable transceivers is that even though the propagation of these frequencies are predominately “line-of-sight”, the propagation of these frequencies nevertheless provides for some diffraction around landscapes and fixed objects. Further, FRS utilizes an FM (F3E narrow-band) modulation scheme which provides clear reception. The Effective Radiated Power (ERP) for F3E narrow-band is 0.500 watts; this ERP facilitates a range of approximately 2 miles, but does not interfere with third-party communications systems that are far away.

Another advantage of using FRS-capable transceivers is that a large variety of hand-held FRS units are commercially available and are compatible for use with this invention. Further, due to the large volume market of FRS units, FRS-compatible components and technology are inexpensive.

Another advantage of using FRS-capable transceivers is that FRS provides 14 channels and 38 privacy codes. The high number of channels and privacy codes provides a large number of unique combinations so that a large number of users may operate privately in the same area at the same time.

Even though FRS would be used in the exemplary embodiment, it will be understood by someone with ordinary skill in the art that other frequency bands, such as, by way of non-limiting example, the General Mobile Radio Service (GMRS), could be used without departing from the spirit of the present invention.

Continuing With reference to FIG. 1, the exemplary distributed mode audio transducer 12 is adapted for generating high volume audio sound waves. As depicted in FIG. 1, exemplary distributed mode audio transducer 12 is retained in exemplary upper housing component 11 with an exemplary retaining bracket 14. In the exemplary embodiment, exemplary retaining bracket 14 is secured to exemplary upper housing component 11 by “heat-staking” protuberances 17 on upper housing 11 that extend through retaining bracket 14. In the exemplary embodiment, exemplary distributed mode audio transducer 12 comprises a top 12a. In the exemplary embodiment, top 12a of exemplary distributed mode audio transducer 12 is mechanically bonded with adhesives to a bottom 8a of an exemplary acoustic interface panel 8.

Another embodiment of the exemplary device 1 would include one or more pistonic voice coils of common design bonded to the acoustic interface panel 8.

Yet another embodiment would use two or more voice coil audio transducers bonded to a single, or split, acoustic interface panel 8. In such an embodiment, the dual audio transducers would facilitate true stereo playback.

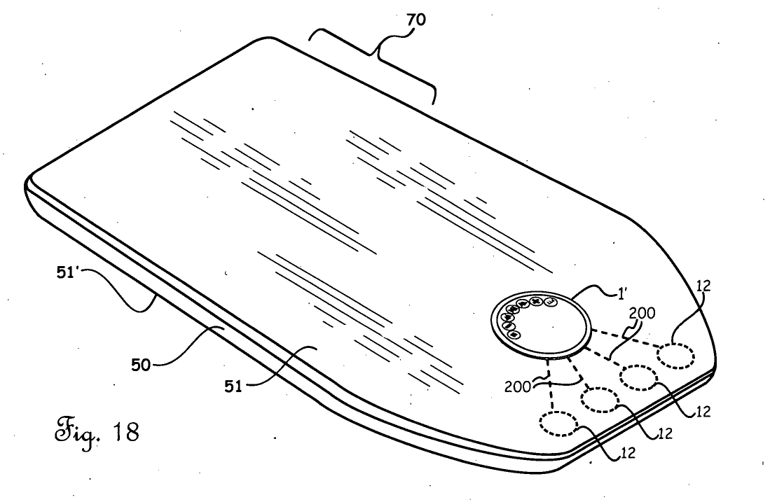

In a still further embodiment of the present invention, one or more distributed mode audio transducers 12 (“exciters”) or other flat panel audio transducers are mounted directly to (on top of; above) the top surface 51 of a body 50 to acoustically drive the body 50. That is, in such an embodiment, the surface 12 of the transducers 12 would be mounted in contact with the top surface 51 of body 50. In such an embodiment, mounting one or more exciters directly to the top surface 51 of a body 50 would provide audio performance while extending only a minimal height above the top surface 51 of the body 50, and would not require a large recess to be opened into the body 50 to receive a device 1′ (see element 1′ depicted in FIG. 18). In such an embodiment, device 1′ (see element 1′ depicted in FIG. 18) would not necessarily comprise any audio transducer enclosed within its housing 10-11.

Yet still another embodiment of the present invention would comprise one or more flat panel audio transducers mounted to a top surface 51 and/or to a bottom 51′ surface (shown, for example, in FIG. 18, and will be understood by someone with ordinary skill in the art to refer to the bottom, underneath surface of body 50) of body 50. In such an embodiment, the flat panel audio transducers provide enhanced wide fidelity music playback.

Continuing with reference to FIG. 1, in the exemplary embodiment, a top surface 8b of exemplary acoustic interface panel 8 is adhesively bonded to a bottom surface 5a of exemplary user interface panel 5. In the exemplary embodiment, by adhesively bonding the top surface 8b of exemplary acoustic interface panel 8 to the bottom surface 5a of exemplary user interface panel 5, audio sound waves generated by audio transducer 12 are conducted to acoustic interface panel 8 which, in turn, conducts the audio sound waves to exemplary user interface panel 5, which causes radiation of the audio sound into the air.

In the exemplary embodiment, exemplary user interface panel 5 is also bonded by adhesives to exemplary upper housing component 11. In turn, audio energy entering acoustic interface panel 5 is propagated through exemplary upper housing component 11 to exemplary rubber ring 7 and then into the body 50. Further, sound waves are conducted through the body of audio transducer 12 and propagate through exemplary upper housing component 11, exemplary lower housing component 10, and exemplary cradle 2, into the body 50.

In an alternative embodiment, it would be possible to provide at least a second flat panel transducer housed within housing 100 that is acoustically coupled to lower housing component 10 for stronger acoustic coupling into body 50.

In the exemplary device 1, printed circuit board 25 comprises circuitry for interfacing with, and connected to, a plurality of exemplary tactile user switches 47; exemplary tactile user switches 47 underlie corresponding exemplary graphic elements 30, 31, 32, 33, 34, 35, and 36 depicted in FIG. 6 on exemplary user interface panel 5. When exemplary tactile user switches 47 are pressed, simple audio tones indicate actuation of the corresponding switch. Special user-defined sound effects and speech can be used to indicate switch actuation or device status changes.

In the exemplary device 1, printed circuit board 25 further comprises circuitry for interfacing with, and connected to, an exemplary submersion sensor 6, and an exemplary microphone 26. When the exemplary device 1 is fully submerged in water, the submersion sensor 6 and corresponding circuitry in exemplary printed circuit board 25 automatically pauses playback of music program. When the submersion sensor 6 is no longer underwater, the submersion sensor 6 and corresponding circuitry in exemplary printed circuit board 25 automatically resumes music program playback at the point where playback was paused upon submersion. This is done in the exemplary embodiment by resuming feeding audio signals from the audio source to the audio transducer 12.

In the exemplary embodiment, exemplary microphone 26 is adapted to receive voice input; exemplary microphone 26 and corresponding microphone circuitry in exemplary printed circuit board 25 are connected to the exemplary two-way FRS transceiver imbedded in exemplary printed circuit board 18 as previously mentioned above. In the exemplary embodiment, exemplary microphone 26 and corresponding microphone circuitry in exemplary printed circuit board 25, exemplary two-way communication antenna 20, and the exemplary two-way FRS transceiver imbedded in exemplary printed circuit board 18 would be adapted for working together for receiving and transmitting two-way voice and communications and data messaging.

In the exemplary embodiment, a microcontroller (e.g., element 204 depicted in FIG. 13) is programmed to monitor the incoming channel of the two-way transceiver. When the microcontroller detects incoming audio signals over the incoming channel of the two-way transceiver, the microcontroller is programmed to pause audio playback through the audio transducer (e.g., element 12 depicted in FIG. 1) to, and switch the audio source for, the feed of audio signals to the audio transducer (e.g., element 12 depicted in FIG. 1) to the incoming channel of the two-way transceiver.

With reference to FIGS. 1 and 3, mechanical retention of the exemplary device 1 to exemplary cradle 2 is achieved via engagement of exemplary cylindrical shaft 45 extends from the recess 10b located in the bottom surface 10a of exemplary lower housing component 10, and exemplary quarter turn fastener 40 located in the center of exemplary cradle 2. FIG. 3 is a partially exploded cross-sectional view of the exemplary device 1, exemplary cradle 2, 1 and exemplary recess 71 in body 50. Exemplary device 1 is docked and mechanically fastened in the cradle 2 by inserting exemplary lower housing component 10 into exemplary cradle 2, and rotating exemplary lower housing component 10 of the exemplary device 1 ninety degrees clockwise until further rotation is stopped. When the exemplary device 1 is fastened into exemplary cradle 2 (i.e., when exemplary device 1 is docked in exemplary cradle 2), exemplary rubber ring 7 contacts surface 51 of body 50.

To disengage the exemplary device 1 from exemplary cradle 2, the process is reversed, rotating exemplary lower housing component 10 of the exemplary device 1 counterclockwise until exemplary device 1 is freed from exemplary cradle 2.

It will be understood by someone of ordinary skill in the art that the use in the exemplary embodiment of exemplary cylindrical shaft 45 located in the recess 10b in the bottom surface 10a of exemplary lower housing component 10, to engage exemplary quarter turn fastener 40 located in the center of exemplary cradle 2 is illustrative and non-limiting. Various alternatives could be used to fasten exemplary device 1 in body 50 without departing from the spirit of the invention. For example, a TY-WRAP™ cable tie fastened to the bottom of exemplary device 1 could be threaded through a whole in the bottom of recess 71 and fastened with a washer on the opposite side of body 50. As a further alternative, the exterior circumference of lower housing component 10 could be threaded to screw into corresponding threading of the interior walls of recess 71, or of the interior walls of a cradle bonded in recess 71, or a threaded shaft that goes through the board. In a yet further alternative embodiment, exemplary device 1 could be fully integrated into body 50 without a cradle. In a still further alternative embodiment, exemplary device 1 could be mounted on the surface 51 of body 50.

FIG. 13 is a high-level block diagram depicting exemplary components of exemplary device 1 in the exemplary embodiment of the present invention. As depicted in FIG. 13, exemplary device 1 comprises exemplary mass storage 200, exemplary user interface circuitry 201, a plurality of sensors 202 (including, for example, an exemplary submersion sensor 202a, an exemplary temperature sensor 202b, an exemplary acceleration sensor 202c, and an exemplary GPS sensor 202d). In other embodiments, other sensors, such as, by way of non-limiting example, a compass sensor, a gyroscopic sensor, an ambient noise sensor, and/or a water depth sensor could be provided without departing from the spirit of the present invention.

The exemplary device 1 further comprises exemplary analog switches 203. Exemplary analog switches 203 correspond to the various exemplary graphic elements 30, 31, 32, 33, 34, 35, and 36 on exemplary user interface panel 5 as depicted in FIG. 6. Exemplary analog switches 203 are connected to an exemplary FRS transceiver 214, an exemplary BLUETOOTH® transceiver 211, an exemplary AM/FM transceiver 212, and an exemplary digital/satellite (e.g., XM™) radio transceiver 213. Analogue audio sound passed through exemplary analog switches 203 is then passed through the Power Amplifier(s) 210 which drive(s) exemplary Speakers 216.

The exemplary device 1 further comprises a battery charger 208, and a power supply 209 that converts Battery voltage (from e.g., rechargeable batteries, element 15, and as depicted in FIG. 1) to regulated voltage levels for use by system circuits.

The exemplary device 1 further comprises a microcontroller (microprocessor) 204, an MP3 Decoder 205, an audio DACS/Signal processor 206, and a microphone (Mic) interface 215.

The exemplary device 1 further comprises a USB port 207.

In the exemplary embodiment, compressed music files may be downloaded from, for example, a personal computer, into Mass Storage 200 by the microcontroller (microprocessor) 204 via the USB port 207 (or alternatively, a wireless 802.11 port).

In the exemplary device, music playback is facilitated by the microcontroller (microprocessor) 204 transferring compressed music files from Mass Storage 200 to the exemplary MP3 Decoder 205 for decompression. Decompressed digital music data is transferred into the Audio DACs 206 and converted into analog audio signals (mono or stereo). Analog audio is passed through the Analog Switches 203, through the Power Amps 210 which drives exemplary Speakers 216. One or more Power Amp 210 and Speaker 216 elements may be employed.

In the exemplary device 1, direct current (DC) power can be passed through the USB port 207 to the Charger 208 (or alternatively through a coupled inductive link), which recharges batteries 15. Battery voltage is converted to regulated voltage levels by Power Supply 209 for use by system circuits.

Further, in an alternative embodiment, audio from an external source, such as, for example, a radio or digital music player, could be entered through a USB port, or other wired or wireless connection(s); of a type whether now known or in the future discovered, that connect to the analog switches 203, the power amps 210 and the audio exciter 216. For example, with reference to FIG. 4, such an alternative embodiment could provide an additional (optional) recess 121 in body 50; the additional recess 121 would be disposed to receive and enclose a separate (optional) audio communication device 120, such as, for example, a radio, a cellular telephone, transceiver, or digital music player such as, by way of non-limiting example, an IPOD™.

It will be understood by those with ordinary skill in the art that in such an alternative embodiment, a separate recess 120 could be provided in the body 50 of the craft for receiving and enclosing a separate music, audio or communication device 120, such as, by way of non-limiting example, an IPOD™, cellular phone, or other separate audio device that is external to, but that communicates with, exemplary device 1. In such an embodiment, the separate audio device 120 would, would use exemplary device 1 for audio amplification of the audio received by the separate device 120 in the separate recess 121.

In such an alternative embodiment, it would be possible for exemplary device 1 to receive or produce a first type of audio signals, for example, radio; separate audio device 120 could receive or produce a second type of audio signal, for example, digital music. Device 120 could also produce a third kind audio signal, for example, two-way communication. Exemplary device 1 in such an embodiment would amplify the audio produced or received by itself, and would also be adapted to amplify the audio received from the separate audio device 120. Alternatively, exemplary device 1 could be adapted for audio amplification, but would not itself produce audio; in such an embodiment, separate audio device 120 could be the sole source of audio for amplification using exemplary device 1.

Continuing with reference to FIG. 13, the exemplary device 1, FRS transceiver 214 receives RF signals via FRS Antenna (see, e.g., element 20 depicted in FIG. 1) and outputs an analog audio signal that can be routed to the Power Amp 210 and Speakers 216 via the Analog Switches 203 under the control of the microcontroller (microprocessor) 204. FRS Radio channel tuning and privacy code detection may be controlled and/or performed by microcontroller (microprocessor) 204 and/or dedicated circuits within the FRS Radio.

In the exemplary device 1, user voice is converted by Mic Interface 215 into an analog signal and passed to the FRS Radio transceiver 214, which modulates the signal on the FRS transmit channel. Alternatively, the microcontroller (microprocessor) 204 can process this voice signal for clarity before being transmitted. FRS Radio transmission is controlled by User Interface 201 input (e.g., Push-to-Talk button). FRS Radio channel and privacy code usage is controlled by default settings, and altered by Master Radio input.

In the exemplary embodiment, pressing the Push-to-Talk button pauses audio playback signals fed to the audio transducer 12 (see, e.g., FIG. 1).

In the exemplary embodiment, the exemplary device 1 operates FRS Radio as a “Slave” to a detected “Master” radio. The Slave monitors a default channel and privacy code and “slaves” itself to the first detected Master to transmit an assignment signal. Once “slaved”, the Master can reassign the channel and/or privacy code assignment so that optimum FRS Radio traffic is attained. The slaved FRS radio follows the master's commands until power is cycled or User Interface 201 commands otherwise.

The BLUETOOTH® Radio transceiver 211 (or similar system) is used to facilitate wireless file transfer from PC's or other external devices to the exemplary device 1, or between two or more devices of the same type, or compatible with, exemplary device 1.

Exemplary microprocessor 204 facilitates music file downloads to Mass Storage 200, and/or, music file uploads to external devices. Alternatively, downloaded music files can also be directed by Microprocessor 204 into exemplary MP3 Decoder 205, bypassing Mass Storage 200. Doing so would allow instantaneous file sharing for real-time playback.

The embodiment depicted in FIG. 13 would include an AM/FM Radio transceiver 212 (or similar) and a Satellite Radio transceiver 213 (e.g., XM or similar) to facilitate receiving AM/FM radio and/or Digital/Satellite radio from external music sources. The Microprocessor 204 (or dedicated circuitry) would control these radio receivers and would direct either an analog audio signal to the Power Amp 210 and Speakers 216 through the Analog Switches 203, or a compressed audio file through the MP3 Decoders 205 to the Power Amp 210 and Speakers 216 through the Analog Switches 203.

In the exemplary device 1, a plurality of sensors 202 connected to the microcontroller (microprocessor) 204 helps the unit maintain optimum configuration and provides the user with information about the user's environment. For example, the submersion sensor 202a pauses music playback when the exemplary device 1 is underwater. Music playback continues when the exemplary device 1 is again above water. The exemplary temperature sensor 202b allows temperature to be verbally announced to the user. Acceleration information sensed by the acceleration sensor 202c can be used to plot velocities and accelerations and can also be used to “dead reckon” a user's course on the water. Global Positioning System (GPS) information from the GPS sensor 202d can provide information to the user about course, speed, direction, and positioning.

FIG. 2 depicts a perspective view of an exemplary human aquatic sports participant 75 riding atop a exemplary body 50 in which the exemplary embodiment of the device 1 is embedded in exemplary body 50. In FIG. 2, exemplary body 50 comprises a bodyboard 70. Because in the exemplary embodiment, exemplary body 50 comprises a bodyboard 70, reference herein to the bodyboard 70 of the exemplary embodiment may be made to bodyboard 50; reference herein to the surface 51 of bodyboard 50 may be made to bodyboard surface 51, or may be made to the top surface 51 of bodyboard 50.

The exemplary embodiment of the device 1 being mechanically connected to bodyboard 50 acoustically couples sound waves into the surface 51 of the bodyboard 50. In the exemplary embodiment, acoustic coupling into the surface 51 of a body 50 is accomplished in at least two ways. First, exemplary rubber ring 7 contacts surface 51 of body 50. It will be understood by someone with ordinary skill in the art that the description of exemplary rubber ring 7 is illustrative and non-limiting. Rather, as will be understood by someone with ordinary skill in the art, it would be possible to use other ways and materials for coupling an audio-excited panel, e.g., exemplary user interface panel 5, to a surface 51 of a body 50 into which an exemplary device 1 is imbedded. For example, members made of various flexible and/or elastomeric materials other than rubber could be used to couple an audio-excited panel, e.g., exemplary user interface panel 5, to a surface 51 of a body 50 into which an exemplary device 1 is imbedded. Further, such members could be formed in various geometries other than a ring.

Another way in the exemplary embodiment that acoustic coupling into the surface 51 of a body 50 is accomplished is by the conducting of sound waves that are propagated by the audio transducer 12 through exemplary upper housing component 11 and exemplary lower housing component 10, then through exemplary cradle 2, then into the body 50, and then through the surface 51 of the body 50.

As mentioned previously above, it would be possible in alternative embodiments, to fasten the audio device directly into a recess in body 50 (e.g., by “screwing” threaded exterior walls of the housing of device 1 into the threaded interior walls of a recess, such as recess 71. In such an embodiment, no cradle would be provided. The direct contact between the housing in such an embodiment, with the interior walls and/or the floor of the recess, e.g., recess 70, in body 50 results in further acoustic sound level that emanates through surface 51. In such an embodiment, a thin coating of the interior walls of the recess, e.g., recess 70 could be applied to protect the body from environmental factors when the device 1 is removed.

It will be understood by someone with ordinary skill in the art that the extent of audio sound level enhancement may be affected by the material composition of body 50. For example, a body 50 comprising STYROFOAM® may tend to better conduct audio sound waves than a body 50 comprised of a solid plastic.

The above-mentioned acoustic coupling enhances many facets of the aquatic sport participant's listening experience. One of the enhancements is overall audio sound level.

Empirical testing shows the audio sound level produced by exemplary device 1, and reinforced by the surface 51 of the exemplary body 50, and the overall exemplary body 50, provides an increase in sound level of approximately 20 db. FIG. 14 is a graph that depicts results of empirical tests regarding audio levels produced by exemplary device 1 of the exemplary embodiment of the present invention. In FIG. 14, the x-axis relates to audio frequency, measured in Hertz (HZ); the y-axis relates to sound level (also referred to as audio amplitude), measured in decibels (dB(A)).

In FIG. 14, plotted curve 66 (a dotted line) reflects the audio profile of the exemplary device 1 as measured when the exemplary device operated in free space. Plotted curve 65 (a solid line) reflects the audio profile of the exemplary device 1 when the exemplary device 1 was mounted into an exemplary bodyboard 50. As depicted in FIG. 14, plotted curve 65 is in most instances, at least as strong as plotted curve 66, and in most cases, is significantly higher. As depicted in FIG. 14, gains in sound level realized by conducting sound energy from the exemplary device 1 into the bodyboard 50 are, in some cases, more than 10 dB(A), and in some cases, as high as 20 dB(A). Frequency response has also been enhanced, especially in the 100-2000 Hz range.

Another enhancement that results from the exemplary device 1 being mechanically and acoustically coupled to bodyboard 50 and bodyboard surface 51, is that the audio spectral response of exemplary device 1 is equalized. That is, bass audio response is increased due to the low frequency resonance of bodyboard 50, and the bodyboard surface 51.

Yet another enhancement that results from the exemplary device 1 being mechanically and acoustically coupled to bodyboard 50 and bodyboard surface 51, is that the entire surface 51 of the exemplary bodyboard 50 acts as a distributed mode sound board or speaker. That is, the audio image presented to the aquatic sport participant 75 sounds like it is fully encircling the participant 75. The entire surface 51 of the exemplary bodyboard 50 acting as a distributed mode sound board or speaker contrasts to a loudspeaker of common design where audio sound emanates from a driver and sounds to the participant as if the audio sound is emanating from a point source.

In the exemplary embodiment, the exemplary device 1 is mounted into exemplary bodyboard 50 so that the top of the exemplary device 1 is flush, or nearly flush, with the top surface 51 of the exemplary bodyboard 50. Thus, in the exemplary embodiment, the exemplary device 1 being recessed into the bodyboard 50 does not interfere with the exemplary bodyboard's 50 normal function. Further, it does not encroach into the participant's 75 domain on the exemplary bodyboard 50.

It will be understood by someone with ordinary skill in the art that recessing exemplary device 1 so that the top of exemplary device 1 is flush, or nearly flush with the top surface 51 of the exemplary bodyboard 50 is illustrative and non-limiting. Without departing from the spirit of the present invention, it would be possible to recess the exemplary device 1 further into the exemplary bodyboard 50 so that a well would be formed in the exemplary bodyboard's surface 51. As a further alternative, exemplary device 1 could be mounted on top of (above) the exemplary bodyboard's surface 51.

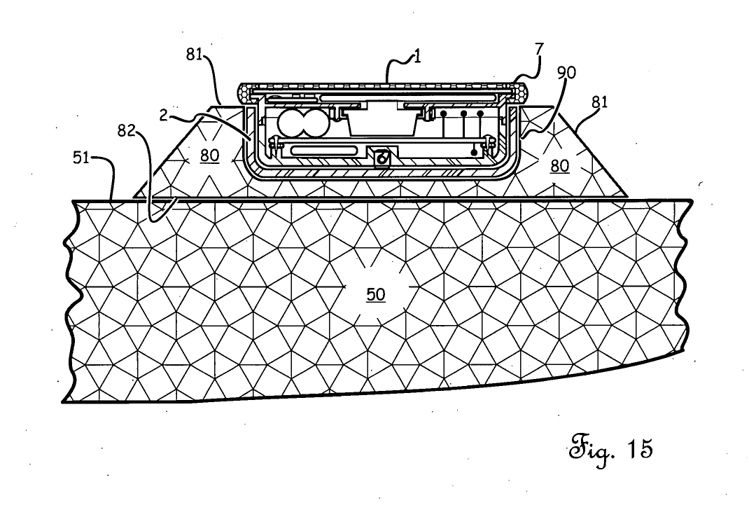

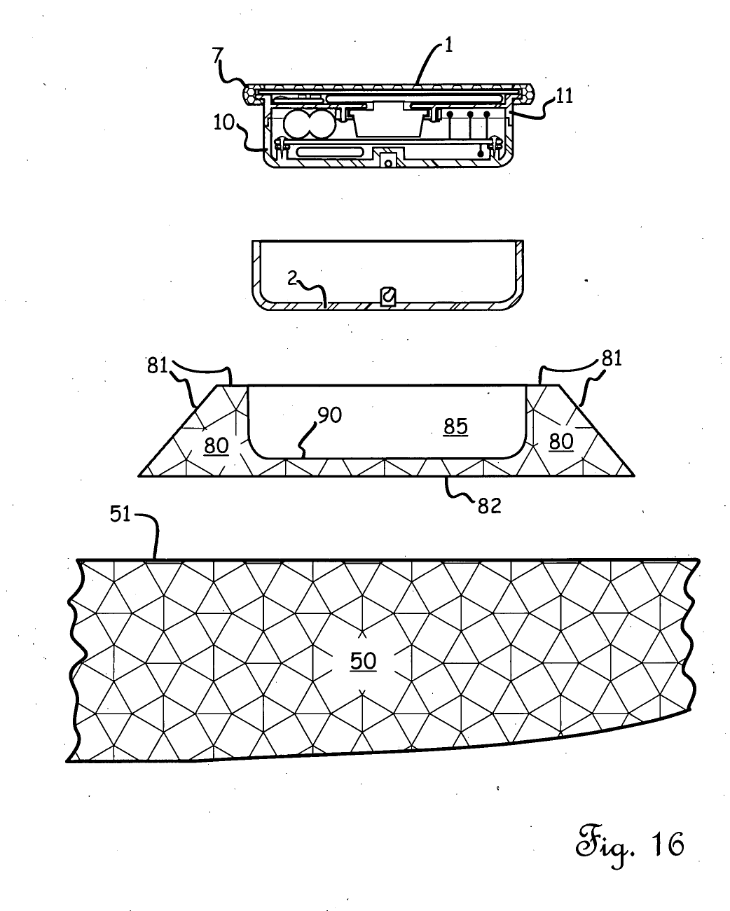

FIG. 15 depicts a cutaway sectional view of an alternative embodiment of the exemplary device 1 in which the device 1 is mounted to the top surface 51 of a body 50. In the alternative embodiment depicted in FIG. 15, exemplary device 1 is mounted into an exemplary cradle 2.

As depicted in FIG. 16, in such a top-mounted embodiment, exemplary cradle 2 is set within a form recess 85 provided in an exemplary form 80. In the alternative embodiment, exemplary form 80 comprises a material adapted for conducting audio waves, such as, for example, STYROFOAM®, Expanded Polypropylene (EPP) foam, or other type of material. Exemplary bottom form surface 82 of exemplary form 80 is bonded to, affixed to, or otherwise in contact with, exemplary surface 51 of body 50.

In such a top-mounted embodiment, audio waves generated by exemplary device 1 are conducted into exemplary cradle 2. Cradle 2 in turn, conducts the audio waves into exemplary form recess surface 90 of the exemplary form recess 85. Audio waves conducted into exemplary form recess surface 90 are then conducted into exemplary form 80 and are then conducted into exemplary surface 51 and then into exemplary body 50.

In the alternative embodiment depicted in FIGS. 15 and 16, exemplary device 1 is similar to that depicted in FIG. 1. In the alternative embodiment depicted in FIGS. 15 and 16, an elastomeric rim 7 conducts audio waves from a device housing (e.g., elements 10-11 depicted in FIG. 16) of device 1 to exemplary form top surface 81. Audio waves are then conducted from the body of form 80 into the exemplary bottom form surface 82, then into the exemplary board surface 51 of the exemplary board 50.

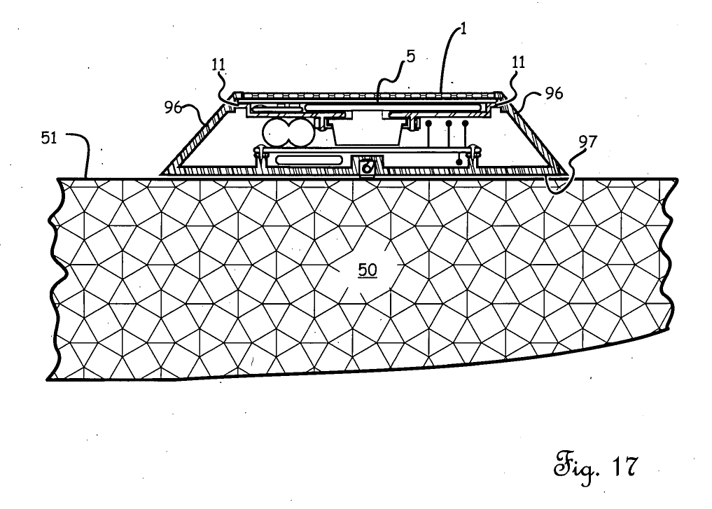

It will be understood by someone with ordinary skill in the art that the alternative embodiment depicted in FIGS. 15 and 16 is non-limiting and illustrative. Other geometries and materials that are adapted for conducting acoustic sound waves and/or support the exemplary device 1 could be used without departing from the spirit of the present invention. For example, FIG. 17 depicts a cutaway sectional view of a further alternative top-mounting embodiment of the exemplary device 1. In the embodiment depicted in FIG. 17, device 1 would provide a low profile, and would be affixed, bonded, or otherwise in contact with the top surface 51 of body 50.

In the further alternative embodiment depicted in FIG. 17, alternative exemplary device 1 would provide an alternative housing geometry that would be formed by joining exemplary upper housing 11 to alternative exemplary lower housing 96. Alternative exemplary lower housing 96 would have an alternative exemplary bottom surface 97. Alternative exemplary bottom surface 97 would be affixed to, bonded to, or otherwise in contact with, exemplary board surface 51. Audio sound waves generated by exemplary device 1 would be conducted into alternative exemplary lower housing 96 and then into exemplary board surface 51. It will be understood by those with ordinary skill in the art that the further alternative embodiment depicted in FIG. 17 is illustrative and non-limiting. Other geometries and materials adapted to conduct acoustic sound waves and/or support the exemplary device 1 could be used without departing from the spirit of the present invention.

Continuing with reference to FIG. 2, in the exemplary embodiment, exemplary device 1 is located towards the front 106 of the exemplary bodyboard 50 allowing the exemplary device 1 to be above the waterline during use. That is, when the participant 75 sits or rides on the exemplary bodyboard 50, the rear 105 of the exemplary bodyboard 50 may tend to be submerged below the waterline. Further, locating the exemplary device 1 towards the front 106 of the exemplary bodyboard 50 generally positions the exemplary device 1 below the participant's 75 head, thereby maximizing audio volumes and audio fidelity for the participant's listening. Even so, it would be possible to position the exemplary device 1 in other locations on the exemplary bodyboard 50 without departing from the spirit of the present invention.

In a further alternative embodiment of the invention depicted in FIG. 18, a device 1′ is recessed in the body 50 of bodyboard 70. In the further alternative embodiment of the invention depicted in FIG. 18, device 1′ would comprise an audio source, a power source, electrical circuitry, a housing, and components similar to exemplary device 1 previously described above, but would not necessarily comprise an audio transducer. Rather, in the further alternative embodiment of the invention depicted in FIG. 18, one or more flat panel audio transducers 12 would be imbedded in the body 50 beneath the top surface 51 of the body 50 of bodyboard 70. In such an embodiment, imbedding one or more flat panel audio transducers 12 in the body 50 would acoustically couple each imbedded flat panel audio transducer 12 to the body 50 and to the top surface 51 (and to the bottom surface 51′) of bodyboard 70. In such an embodiment, the transducers 12 would be connected, for example, by wires 200, to the power source, audio source, and electrical circuitry of device 1′. Acoustic coupling of the imbedded audio transducers 12 to the body 50 and the top surface 51 (and to the bottom surface 51′) result in the bodyboard 70 comprising a sound board or speaker.

Other features of the invention are implicit in the above-provided description and/or are depicted and/or are implicit in the accompanying Figures.

### Facsimile Reproduction of Copyright Material

A portion of the disclosure of this patent document contains material which is subject to copyright protection by the copyright owner, Whobody, Inc., its successors and assigns. The copyright owner has no objection to the facsimile reproduction by anyone of the patent document or the patent disclosure, as it appears in the Patent and Trademark Office patent file or records, but otherwise reserves all copyright rights whatsoever.

### Illustrative Embodiments

Although this invention has been described in certain specific embodiments, many additional modifications and variations would be apparent to those skilled in the art. It is, therefore, to be understood that this invention may be practiced otherwise than as specifically described. Moreover, to those skilled in the various arts, the invention itself herein will suggest solutions to other tasks and adaptations for other applications. Thus, the embodiments of the invention described herein should be considered in all respects as illustrative and not restrictive, the scope of the invention to be determined by the appended claims and their equivalents rather than the foregoing description.

What is claimed is:

1. An apparatus for playing audio signals, the apparatus comprising:
a body of material comprising a top surface;
a flat panel audio transducer;
a housing comprising a top panel, the housing enclosing, and acoustically coupled to, the flat panel audio transducer, the flat panel audio transducer acoustically coupled to the top panel of the housing, the flat panel audio transducer adapted for receiving communications from an audio source, the housing comprised of material adapted for conducting audio waves, the housing acoustically coupled with the top surface of the body of material;
electrical circuitry coupled to the flat panel audio transducer; and
an at least a first power source coupled to the flat panel audio transducer and the electrical circuitry.

2. The apparatus of claim 1, wherein the acoustic coupling of the housing with the top surface of the body of,material comprises an acoustic coupling between the housing and a component of the apparatus selected from the group consisting of:
the top surface of the body of material, a bottom surface of the body of material,
a recess in the body of material,
a cradle recessed in the body of material,
a cradle mounted to the top surface of the body of material,
a form mounted on the top surface of the body of material, and
a cradle mounted in a recess provided in the form mounted on the top surface of the body of material.

3. The apparatus of claim 1:
wherein the housing further comprises a top, an exterior shaft, and a perimeter around the top of the housing;
wherein the body of material further comprises a recess, wherein the recess comprises a floor and an interior wall; and
wherein at least a portion of the housing is disposed within the recess of the body of material.

4. The apparatus of claim 3, the apparatus further comprising:
a member that surrounds the perimeter around the top of the housing and that acoustically couples the housing to the top surface of the body of material.

5. The apparatus of claim 3, wherein the exterior shaft of the housing comprises threading, wherein the interior wall of the recess in the body comprises threading, and wherein the housing is disposed within the recess of the body of material by screwing the threading of the exterior shaft of the housing into the threading of the interior wall of the recess in the body.

6. The apparatus of claim 3, the apparatus further comprising:
a cradle comprising an interior cradle recess and a cradle exterior, wherein the cradle exterior is fastened within the recess, wherein the housing disposed within the recess of the body of material comprises fastening the housing within the cradle recess.

7. The apparatus of claim 6, wherein fastening the housing within the cradle recess disposes an exterior wall of the housing in contact with the interior wall of the cradle recess for acoustic coupling of the housing to the cradle.

8. The apparatus of claim 1, said apparatus further comprising:
an audio source that is adapted for communication with the flat panel audio transducer.

9. The apparatus of claim 8, wherein the audio source is connected to the first power source and wherein the housing encloses the audio source.

10. The apparatus of claim 8, wherein the audio source is external to the housing.

11. An apparatus for playing audio signals, the apparatus comprising:
a body of material comprising a top surface, the body comprising material adapted for conducting audio waves;
an audio transducer, the audio transducer adapted for receiving communications from at least a first audio source;
electrical circuitry coupled to the audio transducer;
an at least a first power source coupled to the audio transducer and the electrical circuitry; and
a housing, the housing enclosing the audio transducer, a portion of the housing disposed within a component of the apparatus, the component of the apparatus selected from the group consisting of:
a recess in the body of material,
a cradle recessed in the body of material,
a cradle mounted to the top surface of the body of material,
a recess provided in a form mounted on the top surface of the body of material, and
a cradle mounted in the recess provided in the form mounted on the top surface of the body of material.

12. The apparatus of claim 11, wherein the first audio source comprises an audio device selected from the group consisting of: a radio transceiver, a digital music transceiver, a digital music device adapted for generating streaming digital audio, an internal FRS radio receiver, an internal digital radio receiver, a wireless data link, and a two-way communication device.

13. The apparatus of claim 11, wherein the audio transducer is a flat panel audio transducer.

14. The apparatus of claim 11, the apparatus further comprising:
a second audio source, the second audio source comprising a two-way communication device;
a detecting device for detecting a receiving by the second audio source of audio signals;
a pausing device for pausing generation by the audio transducer of audio signals received from the first audio source; and
a switching device for feeding audio signals from the second audio source to the audio transducer.

15. The apparatus of claim 11, the apparatus further comprising:
at least a first sensor selected from a group consisting of:
a submersion sensor,
a global positioning sensor,
an acceleration sensor,
a temperature sensor,
a compass sensor,
a gyroscopic sensor,
an ambient noise sensor, and
a water depth sensor.

16. The apparatus of claim 11, wherein the first audio source is disposed in a location selected from the group consisting of: a location external to the housing, and a location enclosed within the housing.

17. An apparatus for playing audio signals, the apparatus comprising:
a flat panel audio interface panel;
a flat panel audio transducer acoustically coupled to the flat panel audio interface panel;
a housing comprising a top panel, the housing enclosing the flat panel audio transducer and the flat panel audio interface panel, the flat panel audio interface panel acoustically coupled to the top panel of the housing, the flat panel audio transducer acoustically coupled to the housing, the housing adapted for docking with a body of material, the flat panel audio transducer adapted for receiving communications from an audio source;
electrical circuitry coupled to the distributed mode audio transducer; and
a power source coupled to the distributed mode audio transducer and the electrical circuitry.

18. The apparatus of claim 17, the apparatus further comprising:
a memory storage device for storing a representation of audio signals.

19. The apparatus of claim 18, the apparatus further comprising:
a computer device programmed for translating the representation of audio signals into a digital representation of audio signals;
the computer device further programmed for relaying the digital representation of audio signals to the flat panel audio transducer; and
the flat panel audio transducer adapted for transforming the digital representation of audio signals into analog audio signals and further adapted for conveying the analog audio signals to the flat panel audio interface panel.

20. The apparatus of claim 17, the apparatus further comprising:
the audio source enclosed within the housing.

21. An apparatus for playing audio signals, the apparatus comprising:
a body of material comprising a top surface, the body comprising material adapted for conducting audio waves;
an audio source recessed in the body of material;
a plurality of flat panel audio transducers, each flat panel audio transducer of the plurality of flat panel audio transducers adapted for receiving communications from the audio source, each flat panel audio transducer of the plurality of flat panel audio transducers acoustically coupled to the top surface of the body of material;
electrical circuitry coupled to each flat panel audio transducer of the plurality of flat panel audio transducers;
a power source coupled to each flat panel audio transducer of the plurality of flat panel audio transducers and to the electrical circuitry.

22. The apparatus of claim 21, wherein an at least a first flat panel audio transducer of the plurality of flat panel audio transducers is disposed within the body of material beneath the top surface of the body of material and is acoustically coupled to the top surface of the body of material from underneath the top surface.

23. The apparatus of claim 21, wherein an at least a first flat panel audio transducer of the plurality of flat panel audio transducers is disposed above the top surface of the body of material, and is acoustically coupled to the top surface of the body of material from above the top surface.

24. An apparatus for playing audio signals, the apparatus comprising:
a body of material comprising a top surface, the body comprising material adapted for conducting audio waves;
an audio source recessed in the body of material;
an at least a first flat panel audio transducer, the at least a first flat panel audio transducer adapted for receiving communications from the audio source, the at least a first flat panel audio transducer acoustically coupled to the top surface and to the body of material;
electrical circuitry coupled to the at least a first flat panel audio transducer;
a power source coupled to the at least a first flat panel audio transducers and to the electrical circuitry.

25. The apparatus of claim 24, wherein the at least a first flat panel audio transducer is disposed within the body of material beneath the top surface of the body of material and is acoustically coupled to the top surface of the body of material from underneath the top surface.

26. The apparatus of claim 24, wherein the at least a first flat panel audio transducer is disposed above the top surface of the body of material, and is acoustically coupled to the top surface of the body of material from above the top surface.
